(19) United States
(12) Patent Application Publication
(10) Pub. No.: US 2022/0215445 A1
(43) Pub. Date: Jul. 7, 2022

(54) SYSTEM AND METHOD FOR FACILITATING CUSTOMER REFERRAL AND ENDORSEMENT OF ENTITIES AND INDIVIDUALS

(71) Applicant: MENTION MY BIZ, INC., Poway, CA (US)

(72) Inventor: Peter Harnish, Poway, CA (US)

(73) Assignee: MENTION MY BIZ, INC., Poway, CA (US)

(21) Appl. No.: 17/656,269

(22) Filed: Mar. 24, 2022

Related U.S. Application Data
(63) Continuation of application No. 15/744,580, filed on Jan. 12, 2018.
(60) Provisional application No. 62/192,492, filed on Jul. 14, 2015.

(51) Int. Cl. G06Q 30/02; G06F 16/955; G06Q 50/00; H04L 51/52

(52) U.S. Cl. CPC G06Q 30/0282; H04L 51/32; G06Q 50/01; G06F 16/955

(57) ABSTRACT

Publically accessible personalized universal resource locators (URLs) link a unique user identifier with a unique identifier of a business, a unique identifier of an individual working at the business, or both. The personalized URL is shared through one or more social networking services, directly to other individuals using email, text message, or other direct methods of communication, or both. Data of referrals made, viewed, and acted upon, for both entities and individuals, are tracked and aggregated. Endorsements and reviews are stored for particular businesses and individuals, with graphical elements, short text, or both used to summarize the aggregate ratings of the endorsements and reviews. The aggregate ratings can be based on a relative scale (that is, compared to other entities) or non-relative objective scales.

### CROSS REFERENCE TO RELATED APPLICATIONS

This application is a continuation application of U.S. application Ser. No. 15/744,580 filed on Jan. 12, 2018, which is a National Stage of International Application No. PCT/US2016/042011 filed Jul. 13, 2016, which claims the benefit of U.S. Provisional Pat. App. No. 62/192,492 filed on Jul. 14, 2015, the entirety of which is hereby incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of networked computer systems, and more specifically toward a system and method for facilitating customer referral and endorsement of entities and individuals. Publically accessible personalized universal resource locators (URLs) link a unique user identifier with a unique identifier of a business, a unique identifier of an individual working at the business, or both. The personalized URL is shared through various methods including one or more social networking services, directly to other individuals using email, text message, or other direct methods of communication, or both. Data of referrals made, viewed, and acted upon, for both entities and individuals, are tracked and aggregated. Endorsements and reviews are stored for particular businesses and individuals, with graphical elements, short text, or both used to individually rate and summarize the aggregate ratings of the endorsements and reviews. The aggregate ratings can be based on a relative scale (that is, compared to other entities) or non-relative objective scales.

A common way to refer a business and get credit for the referral is through the use of business cards that referrers provide to others. Another common way is when the referred individual goes to the business and provides the name of the person who referred them. It has been found that over sixty percent of people forget the name of the business they were referred to and do not take action.

Referrals are commonly made to a business. However, with service industries, the person who works at that business may be the true intent behind the referral, and not the business itself. In fact, the difference in the quality of services provided between persons at a single business may be greater than the quality of services provided between businesses.

The state of the art has provided mobile applications and online platforms that let users find businesses recommended by people they know. These are closed platforms where businesses are asked by the customers to sign-up to provide them offers to share to their friends. The business uses these services as a way to extend offers to their loyal customers.

Enterprise level social referral programs are known that are used for large businesses to track their users and customer referrals. They integrate with software as a service (“SaaS”) providers and other e-commerce integrations. These programs use social networks and the users on them to help turn customers into “ambassadors.” These referrals are tracked by a snippet of JavaScript that is placed on the business's web site.

Referral websites allow users to find a business and leave a star rating as well as a review using text and images to explain their experience with that particular business. Other review websites are for businesses and require a membership creating a more specialized list of reviews written by people who are invested in providing legitimate reviews without the hope of getting something for free. However, these services do not provide a way to refer friends or other users to a business, much less to a person working at that business.

The aforementioned services focus solely on the business, and don't differentiate between individual persons within a particular business.

Thus there has existed a long-felt need for a system and method for the personalized referral of a staff member or a business. There is a further need for a system and method for facilitating referrals and endorsements where the data representing the business referral and the staff member referral is made available to the business thereby enabling the business to see the details of who their largest advocates are and which staff members are receiving the most attention, or referrals. Such a system and method should allow for endorsements, or reviews, to be given to a business or a staff member.

### SUMMARY OF THE INVENTION

The current invention provides just such a solution by having a system and method for facilitating customer referral and endorsement of entities and individuals. Publically accessible personalized URLs link a unique user identifier with a unique identifier of a business, a unique identifier of an individual working at the business, or both. The personalized URL is shared through one or more social networking services, directly to other individuals using email, text message, or other direct methods of communication, or both. Data of referrals made, viewed, and acted upon, for both entities and individuals, are tracked and aggregated. Endorsements and reviews are stored for particular businesses and individuals, with graphical elements, short text, or both used to individually rate and summarize the aggregate ratings of the endorsements and reviews. The aggregate ratings can be based on a relative scale (that is, compared to other entities) or non-relative objective scales.

Embodiments of the current disclosure provide for personalized URLs that are accessible to the public, which differ from other systems known in the art. By focusing on the business as well as staff member referral and endorsement, embodiments of the current disclosure solve the problem that existed when trying to refer a business and hope to target a particular individual that works there in addition to the business itself. The systems and methods disclosed herein, including embodiments of web sites, mobile applications, and other exposed technology integrations, solve the referral issues that previously existed and allow for all size of businesses to have access to data that drives their business forward.

The system and methods herein allow for and in some instances require the use of business profiles, staff member profiles, and user profiles, though anonymous profiles may be used. Each profile includes data related to that specific entity, such as a name, address, user ID password, accumulated points (discussed in more detail below), number of mentions, number of endorsements, and other data about that entity.

Particular embodiments of the current disclosure allow for endorsements and reviews of businesses as well as individuals. Graphical elements representing aggregate ratings of these entities enable fast and efficient communication of the rating without having to wade through multiple reviews and/or endorsements. These badges are visual in nature with a small text tagline to indicate what the badge represents. The aggregate ratings can be based on a relative scale, where the badge represents a rating relative to other entities overall, or for that particular field. Alternatively, a non-relative scale is used, such as rating an entity on a numerical scale or a discrete value scale (such as “bad, good, better, best”), where the badge awarded for that entity does not depend on the rating of any other entity. In yet another alternative, a hybrid rating is used, where a portion, but not all, of the overall rating is based upon the relative scores of other entities. This can help account for fields or regions that have overall high (or low) ratings, whereby a good business, albeit not as good as others, can nonetheless receive a good rating.

It is an object of the invention to provide a platform for customer referrals that are given for both the business and the staff members that work there.

It is another object of the invention to provide a system for endorsing businesses as well as particular staff members that work at those businesses.

It is a further object of this invention to provide a system and method that generate high value analytic data on referrals and endorsements.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

As used herein, the terms entity or entities refer to both businesses and individuals. A staff member is an individual that works for or represents a business, whether as an employee, independent contractor, volunteer, or other relationship. A server system is one or more computer systems that work together to provide functionality to other devices. Cookie data is data sent from the server system to the remote device to provide stateful information and track activity.

A particular embodiment of the current disclosure is a system for referring and endorsing a business comprising a server system, where the server system comprises a non-transitory computer readable medium, where the computer readable medium stores data; where the server system is configured to receive a request for a referral uniform resource locator (URL), where the request for a referral URL includes a business identifier and a user identifier; generate a unique referral identifier; store referral data associated with the unique referral identifier on the computer readable medium, where the referral data comprises the business identifier and the user identifier, and return the referral URL that includes the unique referral identifier; where the server system is further configured to receive a request to access the referral URL; determine the unique referral identifier from the referral URL; access data associated with the unique referral identifier from the computer readable medium; update a business object associated with the business identifier of the data associated with the unique referral identifier; update a user object associated with the user identifier of the data associated with the unique referral identifier; generate cookie data, where the cookie data comprises the unique referral identifier, the business identifier, and the user identifier; and return the cookie and redirect data; where the server system is further configured to receive a request from a user for a new endorsement, where the request for a new endorsement includes a business identifier and a user identifier; access the user's profile from data stored on the computer readable medium using the user identifier from the request for a new endorsement, where the user's profile includes a point value; verify that the user has at least a minimum point value; access data associated with the business identifier from the request for a new endorsement; build an endorsement object, where the endorsement object comprises the business identifier and the user identifier; and store the endorsement object. The unique referral identifier consists of an eight-character non-sequential randomized character string.

Another embodiment of the current disclosure is a method of directing a device to a referral uniform resource locator (URL) comprising the steps of: receiving a request for a referral URL from a first device, where the request for a referral URL includes a business identifier and a user identifier; generating a unique referral identifier; storing referral data associated with the unique referral identifier, where the referral data comprises the business identifier and the user identifier; returning the referral URL that includes the unique referral identifier to the first device; receiving a request to access the referral URL from a second device; determining the unique referral identifier from the referral URL; accessing the referral data associated with the unique referral; updating a business object associated with the business identifier of the referral data associated with the unique referral identifier; updating a user object associated with the user identifier of the referral data associated with the unique referral identifier; generating cookie data, where the cookie data comprises the unique referral identifier; and returning the cookie data and redirect data to the second device, where the redirect data comprises the referral URL. The unique referral identifier consists of an eight-character non-sequential randomized character string. The referral data further comprises a staff member identifier. The method further comprises the step of updating a staff member object associated with the staff member identifier

of the referral data associated with the unique referral identifier. The step of updating a business object comprises adding a hit to the business object, where the hit comprises a unique integer value for a network address. The network address is an IPv4 network address. The hit further comprises source channel details. The step of updating a user object comprises adding a hit to the user object, where the hit comprises a unique integer value for a network address. Once again the network address is an IPv4 network address and the hit further comprises source channel details. The hit for the user object corresponds to a point. The method further comprises the steps of receiving a request for a new endorsement, where the request comprises the user identifier; verifying that the user object associated with the user identifier has a sufficient number of points to provide an endorsement; obtaining additional data objects; building an endorsement object, where the endorsement object comprises the additional data objects; updating the user object associated with the user identifier by removing points; and storing the endorsement object. The additional data objects comprises the business object. The additional data objects comprises a staff member object, where the staff member object comprises the business identifier.

An additional embodiment of the current disclosure is a system comprising a non-transitory computer readable medium, where the computer readable medium stores data objects, where the data objects comprises user objects, business objects, and referral objects, where each user object comprises a unique user identifier, where each business object comprises a unique business identifier, and where each referral object comprises a unique referral identifier, the business identifier of one of the business objects, and the user identifier of one of the user objects; and a processor executing programming logic for interfacing with remote devices through a network connection, the programming logic configured to receive a request for a referral uniform resource locator (URL) from a first device, where the request for a referral URL includes the business identifier of one of the business objects and the user identifier of one of the user objects; generate a unique referral identifier; store a referral object, where the referral object comprises the referral identifier, where the referral object further comprises the business identifier of one of the business objects and the user identifier of one of the user objects received in the request; and return the referral URL to the first device, where the referral URL includes the referral identifier. the programming logic is further configured to receive a request to access the referral URL from a second device; determine the referral identifier from the referral URL; access the referral object with the referral identifier; update the business object associated with the business identifier associated with the referral object; update the user object associated with the user identifier associated with the referral object; and return a business URL to the second device. The data objects further comprises staff member objects, where each staff member object comprises a unique staff member identifier and the business identifier of one of the business objects. The data objects further comprises endorsement objects, where each endorsement object comprises a unique endorsement identifier, the business identifier of one of the business object, and the user identifier of one of the user objects.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a diagram showing the communication links of a system and method for facilitating customer referrals of entities and individuals according to selected embodiments of the current disclosure.

FIG. 2 is a flow chart showing the creation of a referral URL according to selected embodiments of the current disclosure.

FIG. 3 is a flow chart showing the workflow when a referred user accesses a referral URL according to selected embodiments of the current disclosure.

FIG. 4 is a flow chart showing the creation of an endorsement according to selected embodiments of the current disclosure.

FIG. 5 is a diagram showing the relations of various objects stored by the system according to selected embodiments of the current disclosure.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

In a particular embodiment, referring a business, also called mentioning a business, is done from any Internet enabled device that can access a web site or exposed API's, such as through mobile phone applications. A. user searches and finds a business. A business detail page is provided to the user, with an option to refer the business, for example with a button labeled “Mention Us.” The user may log in on the mobile application or API layer. Alternatively, the user may log in through a website or remain anonymous for the referral.

After being logged in or continuing as an anonymous user, a personalized URL is created for linking the user's unique user identifier with the business's unique identifier. In the case of an anonymous referral, this will be a unique URL created based on being anonymous and the business's unique identifier. The personalized unique URL is saved to a database.

The user may now socialize this personalized URL to be viewed by their friends and family via social networking channels (Facebook, Twitter, etc.), electronic mail, or text message in the case of the mobile applications or other exposed API integrations.

When the personalized URL is accessed, a computerized web server system receives a request for the URL and identifies it as a customer referral based on the URL pattern. Using the URL pattern and unique values, it finds and redirects the user to the business's landing page, along with the referral details. The business's landing page can be a web page accessible through the same server system that received the request for the URL, or a separate, remote, and/or distinct server system. When the user is redirected to the business's landing page, or the business's landing page is loaded, the database is updated with the details of which source channel the mention came from (for example, clicked from Facebook, Twitter, etc.), the date and time it occurred, and how many times that personalized URL has been accessed. Additionally, the user's profile that generated the personalized URL, if not anonymous, will be incremented with an additional referral. In this manner, reward “points” for the referral can be accumulated and exchanged for various items or services, whether from the business, operator of the system and method disclosed herein, or some other entity. If the user who accessed the URL decides to submit contact information, that information is saved to the database to be viewed and acted upon by the business.

Referring a business's staff members, similar to referring a business, is done from any Internet enabled device that can access a web site or exposed API's, such as through mobile phone applications. A user searches and finds a business. A business detail page is provided to the user, with an option to refer their staff, for example with a button labeled “Mention Our Staff” The user may log in on the mobile application or API layer. Alternatively, the user may log in through a web site or remain anonymous for the referral.

After being logged in or continuing as an anonymous user, the user will have the opportunity to select a staff member by name from a list of previously entered staff, such as through a pull-down list, or the user may create a new entry for an unlisted staff member.

After selecting a staff member, a personalized URL is created linking the unique user identifier with the business's unique identifier as well as that staff member's unique identifier. In the case of an anonymous referral, this will be a unique URL created based on being anonymous and the business's unique identifier and staff member's unique identifier. The personalized unique URL is saved to a database.

The user may now socialize this personalized URL to be viewed by their friends and family via social networking channels (Facebook, Twitter, etc.), electronic mail, or text message in the case of the mobile applications or other exposed API integrations.

When the personalized URL is accessed, a computerized web server system receives a request for the URL and identifies it as a customer referral based on the URL pattern. Using the URL pattern and unique values, it finds and redirects the user to the business's landing page, along with the referral details, which include a reference to the staff member. The business's landing page can be a web page accessible through the same server system that received the request for the URL, or a separate, remote, and/or distinct server system. When the user is redirected to the business's landing page, or the business's landing page is loaded, the database is updated with the details of which source channel the referral came from (for example, clicked from Facebook, Twitter, etc.), the date and time it occurred, and how many times that personalized URL has been accessed. Additionally, the user's profile that generated the personalized URL, if not anonymous, will be incremented with an additional referral. In this manner, reward “points” for the referral can be accumulated and exchanged for various items or services, whether from the business, operator of the system and method disclosed herein, or some other entity. If the user who accessed the URL decides to submit contact information, that information is saved to the database to be viewed and acted upon by the business, and can be directed directly to the staff member that is associated with the referral.

Another embodiment of the current disclosure provides for endorsing a business that can be done from any Internet enabled device that can access a web site or exposed API's, such as through mobile phone applications. A user searches and finds a business. A business detail page is provided to the user, with an option to endorse a business, for example with a button labeled “Endorse Us.” The user may log in on the mobile application or API layer. Alternatively, the user may log in through a website or remain anonymous for the endorsement.

After being logged in or continuing as an anonymous user, the user is provided with a selection of endorsement badges, which he or she can select to apply to the business. Each endorsement badge includes graphical elements with a small text tagline to indicate what the badge represents.

In a particular embodiment, endorsement badges require “points” that are accrued through referring businesses and their staff members. Points may also be accrued by using the mobile app or by purchasing points directly from the operator of the system disclosed herein.

These points are deducted from the endorsing user's profile when the endorsement badge is applied to a particular business. More specifically, the server system receives a request for applying a particular endorsement to a business by a particular user. The server system verifies that the user has a sufficient number of points to apply the requested endorsement. If the user has a sufficient number of points, the endorsement data is stored by the system. This endorsement is saved in the database as a unique entry for the user and the business linking the business identifier with the user's identifier, along with other ancillary data such as creation date and time. In a further embodiment, the required points for the endorsement are redeemed and deducted from the user's profile, after which the endorsement is stored by the system as discussed above.

While the term points is used herein, any incremental number value can be implemented regardless of the label, such as monetary values or fanciful names.

Further embodiments of the current disclosure provide for endorsing a staff member of a particular business that can be done from any Internet enabled device that can access a web site or exposed API's, such as through mobile phone applications. A user searches and finds a business. A business detail page is provided to the user, with an option to endorse a staff member of the business, for example with a button labeled “Endorse Our Staff.” The user may log in on the mobile application or API layer. Alternatively, the user may log in through a web site or remain anonymous for the endorsement.

After being logged in or continuing as an anonymous user, the user selects a staff member by name from a list of previously entered staff, such as through a pull-down list, or the user may create a new entry for an unlisted staff member. The user is then presented with a selection of endorsement badges, which the user selects to apply to the staff member. Each endorsement badge includes graphical elements with a small text tagline to indicate what the badge represents.

In a particular embodiment, endorsement badges require “points” that are accrued through mentioning businesses and their staff members. Points may also be accrued by using the mobile app or by purchasing points directly from the operator of the system disclosed herein. These points are deducted from the endorsing user's profile when the endorsement badge is applied to a particular staff member of a business. More specifically, the server system receives a request for applying a particular endorsement to a staff member by a particular user. The server system verifies that the user has a sufficient number of points to apply the requested endorsement. If the user has a sufficient number of points, the endorsement data is stored by the system. This endorsement is saved in the database as a unique entry for the user and the staff member of a business linking the staff member's identifier with the user's identifier, along with the business's unique identifier and other ancillary data such as creation date and time. In a further embodiment, the required points for the endorsement are redeemed and deducted from the user's profile, after which the endorsement is stored by the system as discussed above.

Another aspect of the current disclosure is enabling business owners to easily see who their largest advocates are and who is being referred to their places of business and to which staff members. To this end, the system enables the businesses to analyze all data that is stored in the database for their business, including the following areas: staff members, campaigns, referral leads, statistics, campaign reports, referrals or mentions, and a dashboard with more generalized information.

The dashboard shows the high level graph of data illustrating how many times a personalized mention link has been clicked. Also, if a campaign URL has been created it will show that as well. A campaign URL is a personalized URL created by the business for the business to share on their social networks and elsewhere. The campaign URL is similar to a “self” referral.

The staff member area allows modification of staff member information but also provides the ability to see a snapshot of each staff member's referral activity.

Campaigns are where the business owner can create personalized URLs for its business. This is essentially a way to refer itself and track it to a particular campaign. This area allows them to see details on the campaign name, leads generated, URL and date created.

When a personalized URL link has been clicked, there is an opportunity for the user who accessed the personalized URL to leave their information for the business to contact the potential new customer. The referral leads area shows these details for the business and allows them to easily track and manage new customer referrals.

The statistics made available by the system can be separated into various categories, including: referrals correlated to the referrer, and referrals correlated by the source channel. The referrals correlated to the referrer enable a business to see which of their customers (referrers) are the most active with referring other people to their business/staff. This data can include the user's name that was doing the mentioning, his or her email, the staff member mentioned if applicable, the date, and the number of leads generated. The referrals correlated by the source channel shows a data depicting the location/service that a particular mention came from. For example, a user mentions Business A on Facebook and ten people click his link. The user also mentions Business A on Twitter where only two people click on his link. The system will show that ten mentions came from Facebook and two came from Twitter thereby allowing Business A to target their marketing to the channel where their customers are most engaged.

The campaign reports area allows a business to analyze the hits to a particular campaign URL using various graphical tools, including a bar graph. The referral area shows data for a particular date range and allows the business to see the number of business referrals versus staff member referrals on a given date.

In addition to driving referrals for businesses and their staff, further embodiments of the current disclosure provide for the ability for a business and their staff to receive endorsement badges based on the quality of their work. This is an easy way to aide in performance evaluations as one can clearly see what the clients of a particular business think of a staff member. A dashboard provides a quick snapshot of total number of endorsements provided for a business and for their staff. A staff member area allows for modification of staff member information as well as provides the ability to see a snapshot of each staff member's endorsement badges and the quantity of each they have received.

An endorsement area allows businesses to see both staff member and business endorsement details, including particular endorsement badges given to them, the user that gave them (or anonymous if applicable), and the date they were given on. Charts or graphics can also be provided by the system, such as a graph based on a date range to show the number of business and staff member endorsements given on a certain date.

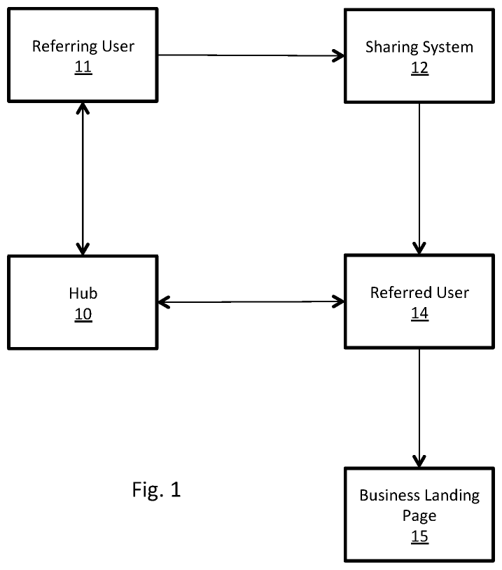

FIG. 1 is a diagram showing the communication links of a system and method for facilitating customer referrals of entities and individuals according to selected embodiments of the current disclosure. A “hub” (10) exists on a server system, and other devices and systems interact with the hub to produce the ability to refer and endorse staff members and the businesses they work at. It is the central hub where the data required for advanced analytics is generated, stored, and retrieved.

A referring user (11) interacts with the hub (10) to generate referral URLs and endorse businesses and staff members of those businesses. The referring user (11) makes a request to the hub (10) for a referral URL. The hub (10) generates the referral URL and then returns it to the referring user (11). The referring user (11) can then share that referral URL through various sharing systems (12), including without limitation social networking sites such as Facebook and Twitter, as well as via more direct methods of communication, such as text message and email. A referred user (14) views and then accesses the referral URL. When accessing the referral URL, or stated another way, when the user clicks on the URL, the user is directed to the hub (10). The hub (10) processes the request of the referred user (14), and then redirects the referred user (14) to the business's landing page (15). More particularly, the hub (10) sends redirect data to the referred user (14), who then uses that redirect data to access the business's landing page (15).

An embodiment has the hub (10) itself using Nodejs. Node.js is a JavaScript runtime that executes JavaScript code quickly due to compiling it into native machine code. It has an event loop which is a single thread that performs all input and output operations asynchronously. This allows a significant gain with web applications and mobile applications dependent on stored JavaScript objects. Reading and writing to network connections, the file system, and databases occurs quickly because of its non-blocking nature. Exposing a REST-ful server side API with Node.js allows a rich client framework like Angularjs to pass data back and forth without translating it from one format to another.

A further embodiment uses MongoDB as the data store option to work in tandem with Node.js. By using a data store that holds JavaScript objects for all data flowing in and out of the hub, the objects for referrals and endorsements can be persisted from the client, to the server, and into the database using JavaScript Object Notation (JSON).

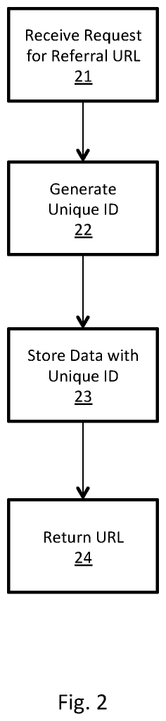

FIG. 2 is a flow chart showing the creation of a referral URL according to selected embodiments of the current disclosure. When a user decides to mention a staff member and/or the business that they work for, the system receives a request to generate a referral URL (21). The Nodejs REST API is called to create a unique URL. This URL has important characteristics that allow the hub to work correctly.

The referral URL is accessed using a secure protocol over Hypertext Transfer Protocol (HTTP) within a connection encrypted by Transport Layer Security (HTTPS). The URL requests that are sent to the hub for mentions should be given on a secure protocol to facilitate a secure referral and allow for the persistence of the referrer header details regardless of where the link was accessed. This referrer data is important for understanding the channel from which the referral was created.

The system generates a unique identifier (22) for use with the referral URL. The referral URL is identified by the unique identifier, which in a particular embodiment consists of an eight-character non-sequential randomized character string. This unique string combination is the key to a JavaScript object that is stored (23) in the database containing all of the information for that client referral including without limitation business page URL, business identifier, staff member details, the user that referred the business, leads created from the referral, the campaign to attribute for the referral, and search engine optimized data for the business. The eight-character non-sequential randomized string allows for well over two trillion unique keys. Once the data is stored with the unique identifier (23), the referral URL is returned to the user (24) for sharing through various social networking or other methods of electronic communication.

When a potential new customer accesses the referral URL, the hub generates data on the referral and subsequently attributes the user that referred the new customer through the shared URL. All of this data is made available to the business.

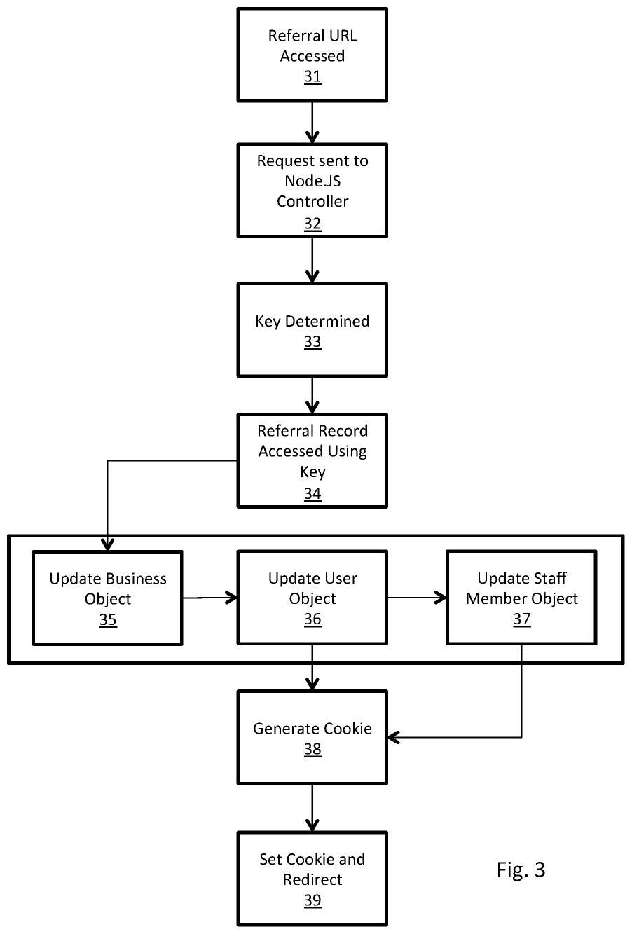

FIG. 3 is a flow chart showing the workflow when a referred user accesses a referral URL according to selected embodiments of the current disclosure. A referred user accesses the referral URL (31), for example, by clicking on a link embodying the URL. The Node.js route handler is used to direct specific URLs that are requested to the hub. Upon recognizing a mention URL, the route handler directs the request to the appropriate Node.js controller (32) to process the secured referral URL. That URL is run through a preprocessor which strips out the shortened secured URL that was sent to the handler to determine the key (33), or unique identifier, and performs a lookup in the database. The lookup in the database uses the key to access the record of the referral object referenced by the key (34). The stored JavaScript object defines the details of the referred business, and staff member if applicable, received in the request. With a key-value database such as MongoDB being used for its increased speed for simple JavaScript object manipulation, ability to nest required schemas in the model layer, and ease at which objects can be ingested from front-end services, the retrieval process and preprocessing is extremely efficient.

The unique eight-character non-sequential randomized character string used to look up the referral object returns all of the additional data for that particular user's referral including, but not limited to, business page URL, business identifier, staff member details, the user that referred the business, leads created from the referral, the campaign to attribute for the referral, and search engine optimized data for the business.

Successful retrieval of a mention object from the MongoDB triggers the addition of a “Hit” or visit to the business's stored JavaScript object in the database, where the system updates the object for that particular business (35). This is done via a unique integer value for an IPv4 network address so that a distinction can be made between a raw hit and a unique hit restricting the ability to repeatedly record unique visits and maintaining the details of the source channel the hit came from and the campaign, if any, it was part of for that business. The system also updates the referring user's object (36) in the database. It is the recording of a unique “hit” that also adds digital points to the user's JavaScript object in the database that made the original referral. If the referral referenced a particular staff member, then the staff member is also updated (37) accordingly. The unique integer for the IPv4 network address continues to eliminate the false increments of points. As will be appreciated by those in the art, a unique integer value for an IPv6 network address may be used in place of the IPv4 network address where the circumstances dictate.

When the preprocessor has finished the referral object that has been accessed, it is then processed by the final stage of the route controller. This processor takes the data stored in the referral object and creates a cookie (38) of the values that is then sent back to the user's device as part of the response when the request is redirected to the full URL (39) which was part of the referral JavaScript object and redirects to the actual business landing page with all of the referral data.

The user who originally interacted with the referral URL will now see the business landing page with a contextual message explaining that the user who created the referral URL referred them to a particular staff member at a business. If the user decides to leave their information for the staff member or business to contact them, the client framework will use the Node.JS REST-ful API to update the JavaScript object for the mentioned referral to include their details as an active lead.

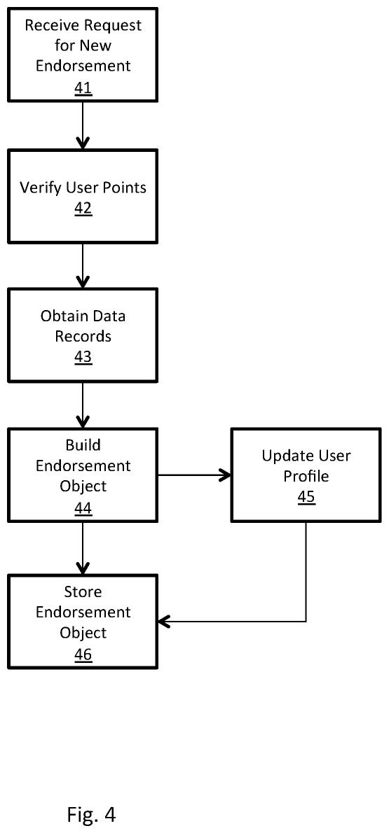

FIG. 4 is a flow chart showing the creation of an endorsement according to selected embodiments of the current disclosure. When a user decides to endorse a staff member and the business that they work for, the user sends and the system receives a request for a new endorsement (41). The system verifies that the user requesting the endorsement has sufficient points (42) to complete the endorsement, which includes accessing the requesting user's object or profile. Points, described above, provide a way of limiting the number of endorsements made by users, thereby increasing their perceived value when made. The Node.js REST API is called to create an association between the staff member, business identifier, and the endorsement badge details creating an endorsement order. When the Nodejs router retrieves a request to endorse a staff member and the business they work for, the request contains the staff member identifier, the business identifier, any additional comments for the endorsement, and the endorsement identifiers that need to be linked together in a single JavaScript object that is easily, and quickly, retrieved without any transformation. In other words, the system obtains the additional appropriate objects from the database (43), including the business's object and the staff member's object, if appropriate. The system makes a request to the database to retrieve the objects for the staff member, endorsements, and the user who is giving the endorsement. It is this combination of JavaScript objects that creates a final endorsement for a staff member, which is tracked to a user.

A staff member JavaScript object stored in the database is unique by a staff member name and business identifier. The business identifier is a textual identifier that references the business a staff member works for and is the identifier that all details around a business are stored against. The endorsement JavaScript object contains fields including, but not limited to, the description, the image, and the endorsement badge, and can be associated to a staff member, business, and user.

When those objects are successfully returned the API creates a new JavaScript object consisting of the aggregate values for those three objects (44) and stores the endorsement object (46) in the database. With the endorsement object stored with indexes on the business identifier and staff member identifier, the Angular.js front end platform will have direct access via Nodejs API to those endorsements. During the store process for the new endorsement order the details for when and who created this endorsement are also stored as part of the endorsement order for customer analysis and insight gathering through analytics as part of the hub. During, before, or after the process of building an endorsement object (44), the user's profile (or object) may be updated. For example, in a particular embodiment, the points accumulated by the user may be deducted from their profile. This change in the object is stored to the database to update the user's profile (45).

When a user accesses the business's landing page, the Angularjs framework will make a call via Angular.js service to the Node.JS API layer. This layer will look for all of the endorsement objects for the current business identifier and return those associations to the Angular.js framework to be displayed. Furthermore, if a user accesses a page for a particular staff member of the business, the endorsements for that particular staff member may be accessed in a similar manner. Additionally, when accessing the business's landing page, endorsements of all staff members working at that business may be accessed and displayed to a user.

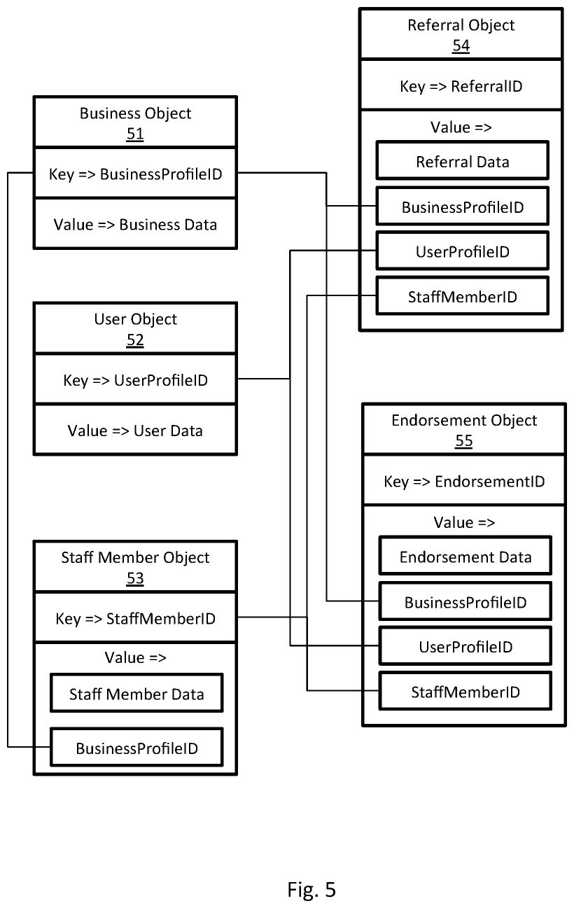

FIG. 5 is a diagram showing the relations of various objects stored by the system according to selected embodiments of the current disclosure. A business object (51) has a unique identifier for that business, also referred to as a business profile identifier. The value associated with this key includes business's profile data associated with that particular business.

A user object (52) has a unique identifier for that user, also referred to as a user profile identifier. The value associated with this key includes the user's profile data associated with that particular user.

A staff member object (53) has a unique identifier for that staff member, also referred to as a staff member identifier. The value associated with this key includes staff member data associated with that particular staff member, as well as a business profile identifier that associates that staff member with a particular business.

A referral object (54) has a unique identifier for that referral, also referred to as a referral identifier. The value associated with this key includes referral data associated with that particular referral, as well as a business profile identifier, user profile identifier, and if applicable, a staff member identifier. The business profile identifier associates the referral object with a particular business. The user profile identifier associates the referral with a particular user, such as the user that is making the referral. If the user refers a specific staff member at the business, then a staff member identifier is also included with the referral object, where the staff member identifier associates the referral object with a particular staff member of the referred business.

An endorsement object (55) has a unique identifier for that endorsement, also referred to as an endorsement identifier. The value associated with this key includes endorsement data associated with that particular endorsement, as well as a business profile identifier, user profile identifier, and if applicable, a staff member identifier. The business profile identifier associates the endorsement object with a particular business. The user profile identifier associates the endorsement with a particular user, such as the user that is making the endorsement. If the user endorses a specific staff member at the business, then a staff member identifier is also included with the endorsement object, where the staff member identifier associates the endorsement object with a particular staff member of the endorsed business.

Embodiments of the system and method disclosed herein provide for a customer referral, endorsement and analytics platform that is used to allow customers of a business to refer either the business, or one of their staff members, to another person. It is also used to endorse a business or staff member with a visual depiction of a positive or negative experience. This reduces the requirement to read long descriptions to know if a business or a staff member is good or bad. Finally, it is used by businesses to track and analyze the details around their customer referrals and endorsements to better understand who is promoting their business and whom they should reward.

An example use case of selected embodiments of the current disclosure has a user named Jason that had a great meal at a new restaurant that he tried. Jason is on his laptop and goes to a web site to access the referral system. He creates a personalized URL that he shares on his Facebook wall. His friends see the link and click to learn more about the new restaurant. Several of them leave their details for the business.

The new restaurant has an account with the system and when they log in, they see that their top customer referrer is Jason. They see that he has driven fifty-two people to their business's landing page through his referral URL and that almost all of them have come from Facebook, with eight of them leaving their contact information.

Seeing this data, the restaurant sends the eight people who left their details a coupon in their email and sends Jason an email telling him to come in for a free meal for his help in getting more customers to their restaurant.

Another example use case of selected embodiments of the current disclosure has a user named Beth who is walking down the street and sees a co-worker, Sarah. They are making small talk when Sarah mentions how much she loves Beth's hair and asks where Beth gets it done. Beth only goes to Brian at Bloomington's Salon. She tells Sarah that she should really go there and starts up a mobile application. Going to her frequently mentioned business list, she moves through the app to share Brian at Bloomington's Salon with Sarah. She asks Sarah for her phone number and texts her the referral URL while standing there on the street. Sarah thanks her for the referral and continues on her way.

A week later Sarah remembers that she wanted to go see that person that Beth recommended. She opens the text message and accesses the referral URL link. The link opens in a mobile application and she sees the referral in her list from Beth. She is able to get the business contact information and requests an appointment with Brian.

Yet another example use case of selected embodiments of the current disclosure has a family owned and run shoe store that is very dependent on their sales people being personable and doing their job well. As such, they have decided to use the referral and endorsement method to help them assess performance for their employees. They instruct their customers to use the site or the app to give endorsements and refer the shoe store to their friends.

After the quarter has ended, the shoe store's owners look at their employees' endorsement and referral statistics. They are able to quickly see who their most endorsed employee is and who gets referred to the most. Although that employee has the most endorsements and referrals, they can also see that several employees have only positive endorsements, while the employee with the most endorsements and referrals has a mixture of good and bad endorsements. This allows the owners of the shoe store to discuss with their employees all of the feedback they have along with ways to improve in certain areas depending on the endorsement badges they have received.

An additional example use case of selected embodiments of the current disclosure has a major electronics retailer who would like the ability to use the referral and endorsement system as an incorporated subsystem of the current online system to allow their customers to get even more insight into their retail locations and which employees are the best in their given field.

The electronics retailer is given API access to the system and method, including access to the system's server and database data for their particular employees and locations. Using that API, the electronics retailer is able to access all of the data concerning their 500 locations and display it on their own web sites and internal reporting systems. The easily defined endorsement badges provide for a way to enable quick reviews and the exposed API's allow for easy recommendations from their own site. Stated another way, the business, staff members, and users access the system and method through a proxy system, in this instance, the electronic retailer's online system and applications.

It should be understood that while various embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

That which is claimed:

1. A server system for creating an endorsement of a staff member from a user, the server system comprising:
a processor; and
a non-transitory computer readable medium, where the computer readable medium stores data;
wherein the server system is configured to:
receive a request for a new endorsement of a staff member by the user, where the request for a new endorsement includes data indicative of a business identifier, a staff member identifier, and a user identifier;
access business data associated with the business identifier;
build an endorsement object, where the endorsement object comprises the business identifier, the staff member identifier, and the user identifier;
providing the user with a selection of staff member endorsement badges;
accept endorsement data from the user, the endorsement data including at least one identifier of an endorsement badge for the staff member, the endorsement badge including a graphical element and a small text tagline to indicate what the badge represents; and
store the endorsement object including the endorsement data.

2. The server system of claim 1, wherein the endorsement data includes a plurality of staff member endorsement badge identifiers.

3. The server system of claim 1, wherein the processor is further configured to:
provide the user with a selection of endorsement badges for a business;
wherein the endorsement data from the user further comprises at least one identifier of an endorsement badge for the business associated with the business identifier and wherein the at least one identifier of the endorsement badge for the business is stored in the endorsement object.

4. The server system of claim 1, wherein the processor is further configured to:
in response to the request for a new endorsement of a staff member by the user, verify a number of points associated with the user; and
refrain from storing the endorsement data if the number of points is not sufficient for creating a new endorsement.

5. The server system of claim 1, wherein the processor is further configured to:
receive a request for retrieval of the endorsement for the staff member; and
respond to the request by retrieving and transmitting the endorsement for the staff member.

6. The server system of claim 1, wherein the processor is further configured to:
receive a request for a referral uniform resource locator (URL) from a first device, where the request for a referral URL includes the business identifier, the staff member identifier, and the user identifier;
generate a unique referral identifier that serves as a key to a referral object comprising referral data;
store the referral object data associated with the unique referral identifier on the computer readable medium using the unique referral identifier as a key, where the referral object comprises the business identifier, the staff member identifier, and the user identifier, wherein the unique referral identifier is different from the business identifier, the staff member identifier and user identifier and combinations thereof, and wherein the unique referral identifier is different from the referral URL; and
return the referral URL that includes the unique referral identifier.

7. The server system of claim 6, wherein the processor is further configured to:
receive a request to access the referral URL from a second device;
determine the unique referral identifier from the referral URL;
access data associated with the unique referral identifier from the computer readable medium using the unique referral identifier as a key;
update a business object associated with the business identifier of the data associated with the unique referral identifier;
update a staff member object associated with the staff member identifier of the data associated with the unique referral identifier;
update a user object associated with the user identifier of the data associated with the unique referral identifier;
generate cookie data, where the cookie data comprises the unique referral identifier, the business identifier, the staff member identifier, and the user identifier; and
return the cookie and redirect data.

8. A method for creating an endorsement of a staff member from a user, the method comprising:
receiving a request for a new endorsement of a staff member by the user, where the request for a new endorsement includes data indicative of a business identifier, a staff member identifier, and a user identifier;
accessing business data associated with the business identifier;
building an endorsement object, where the endorsement object comprises the business identifier, the staff member identifier, and the user identifier;
providing the user with a selection of staff member endorsement badges;
accepting endorsement data from the user, the endorsement data including at least one identifier of an endorsement badge for the staff member, the endorsement badge including a graphical element and a small text tagline to indicate what the badge represents; and
storing the endorsement object including the endorsement data.

9. The method of claim 8, wherein the endorsement data includes a plurality of staff member endorsement badge identifiers.

10. The method of claim 8, further comprising:
providing the user with a selection of endorsement badges for a business;
accepting from the user at least one identifier of an endorsement badge for the business associated with the business identifier; and
storing the at least one identifier of the endorsement badge for the business in the endorsement object.

11. The method of claim 8, further comprising:
in response to the request for a new endorsement of a staff member by the user, verifying a number of points associated with the user; and
refraining from storing the endorsement data if the number of points is not sufficient for creating a new endorsement.

12. The method of claim 8, further comprising:
receiving a request for retrieval of the endorsement for the staff member; and
responding to the request by retrieving and transmitting the endorsement for the staff member.

13. The method of claim 8, further comprising:
receiving a request for a referral uniform resource locator (URL) from a first device, where the request for a referral URL includes the business identifier, the staff member identifier, and the user identifier;
generating a unique referral identifier that serves as a key to a referral object comprising referral data;
storing the referral object data associated with the unique referral identifier on the computer readable medium using the unique referral identifier as a key, where the referral object comprises the business identifier, the staff member identifier, and the user identifier, wherein the unique referral identifier is different from the business identifier, the staff member identifier and user identifier and combinations thereof; and
returning the referral URL that includes the unique referral identifier.

14. The method of claim 13, further comprising:
receiving a request to access the referral URL from a second device;
determining the unique referral identifier from the referral URL;
accessing data associated with the unique referral identifier from the computer readable medium using the unique referral identifier as a key;
updating a business object associated with the business identifier of the data associated with the unique referral identifier;
updating a staff member object associated with the staff member identifier of the data associated with the unique referral identifier;
updating a user object associated with the user identifier of the data associated with the unique referral identifier;
generating cookie data, where the cookie data comprises the unique referral identifier, the business identifier, the staff member identifier, and the user identifier; and
returning the cookie and redirect data

15. A method for assisting employee evaluations, the method comprising:
providing a dashboard to an evaluator, the dashboard comprising a total number of endorsements provided for staff members of the business;
receiving a selection of a staff member from the evaluator;
in response to receiving the selection, searching endorsement objects for the selected staff member and displaying to the evaluator an indication of each particular endorsement badge received by the selected staff member from a reviewer, and a number of times each particular endorsement badge was received by the staff member.

16. The method of claim 15, further comprising displaying a date for each endorsement badge received by the selected staff member.

17. The method of claim 15, further comprising displaying an identifier of a user from whom each endorsement badge received by the selected staff member.

18. The method of claim 15, wherein the selection of a staff member is received by a server system via an application programming interface from a device associated with the business.
